(19) United States
(12) Patent Application Publication
(10) Pub. No.: US 2011/0107412 A1
(43) Pub. Date: May 5, 2011

(54) APPARATUS FOR DETECTING AND FILTERING DDOS ATTACK BASED ON REQUEST URI TYPE

(76) Inventors: TAI JIN LEE, Seoul (KR); YongGeun Won, Seoul (KR); ChaeTae Im, Songpa Gu (KR); HyunChul Jeong, Seoul (KR)

(21) Appl. No.: 12/917,881

(22) Filed: Nov. 2, 2010

(30) Foreign Application Priority Data
Nov. 2, 2009 (KR) 10-2009-0104781

(51) Int. Cl. G06F 17/00

(52) U.S. Cl. 726/11

(57) ABSTRACT

Provided is an apparatus for detecting and responding to a DDoS attack. The apparatus includes: a receiver unit configured to receive an HTTP request from a client terminal having a predetermined IP address; a data measuring unit configured to compute a number of a pre-defined URI in the received HTTP request by IP for a predetermined measuring time period; a DDoS discrimination unit configured to compare the computed number of the pre-defined URI with a pre-defined threshold and configured to detect an access of the client terminal with the IP address as the DDoS attack when the number of the pre-defined URI is greater than the threshold; and a blocking unit configured to block the access of the client terminal when the DDoS discrimination unit detects the DDoS attack.

### BACKGROUND OF THE INVENTION

1. Field of the Invention

The present invention relates to an electronic apparatus, especially to an application layer DDos attack detecting and responding apparatus based on request URI type.

2. Description of the Related Art

Distributed Denial of Service (DDoS) attacks have long caused great damage, and recent botnet-based attacks such as Netbot Attacker, Blackenergy and 7.7 DDos are making it more difficult to respond. The earlier DDos attacks such as SYN, UDP, SYN+ACK and ICMP Flooding tended to consume bandwidth on the network layer. Recently, application-layer DDos attacks which exploit the system's CPU, memory, DB server resources, etc, occurred including HTTP GET Flooding and Cache Control (CC) Attack.

Most of the existing DDos defense tools are designed, however, to cope mainly with network layer DDos attacks, not with application layer DDos attacks such as Netbot Attacker and Blackenergy which generate small amount of HTTP traffics but make victim hosts unavailable. Various types of attacks can be carried out, including HTTP Get Flooding and CC Attack as well as the network-layer DDos attacks.

In recent years, several studies have been reported to deal with the application-layer DDos attacks. For example, given that IP addresses are not uniformly distributed in Web services and that users are likely to revisit the web site, by using traffic analysis, the proportion of regular users can be utilized in the detection of a DDos attack. Using Web services usage pattern analysis, suspicious IP addresses can be classified as ‘Greylist’ to which less resources are allocated. Statistical approaches can be applied on the URL page-hit distribution in attempt to distinguish between a sudden spike in requests and a DDos attack. Other defense methods are also proposed including the web usage path analysis and Admission Control for abnormal users.

Under the conventional technology, however, the URL page-hit distribution requires heavy computation, varies widely with time and contents to be delivered, and thus results in challenges with regard to a threshold configuration. The Admission Control method is deployed in an in-line configuration, not in out-of-path configuration, thus requiring session management.

Furthermore, HTTP requests may be grouped into a direct request by a user's action and an indirect request accompanying the direct request, so that conventional DDoS detection method based on a threshold for HTTP PPS is short of accurateness since the threshold is bound to be high. Especially, the conventional method is vulnerable to up-to date DDoS attack that paralyzes the system with small amount of HTTP requests.

The above mentioned background arts have been possessed or acquired in the course of eliciting the invention by the inventor. Therefore it is not conclusive that they are prior arts disclosed to the public.

### SUMMARY OF THE INVENTION

The present invention aims to provide a DDos attack detecting and defending apparatus based on URI type capable of performing a defense mechanism with minimum arithmetic complexity.

The present invention aims to provide a DDos attack detecting and defending apparatus based on URI type capable of performing an algorithm for detecting and defending application layer DDos attacks applicable for web service which is a main target of the DDoS attacks.

Additional objects of the present will also be driven without difficulty through the following description.

One aspect of the present invention is a DDoS attack detection and response apparatus, the DDoS attack detection and response apparatus includes: a receiver unit receiving HTTP requests from the client terminal which is characterized as an IP address; a data measuring unit computing the number of pre-defined URIs in the received HTTP requests by IP for a time period; a DDoS discrimination unit comparing the number of pre-defined URIs with a pre-defined threshold and defining an access of the client terminal with the IP as a DDoS attack when the number of the pre defined URIs is above the threshold; and a blocking unit blocking an access of the client terminal if the DDoS discrimination unit detects a DDoS attack.

In one example embodiment, the threshold may be determined from the equation:

T=R×T_{U}

Where T is the threshold, R is a pre-determined ratio of the number of HTTPs by a user's action to the number of pre-defined URIs, and TU is a user's action threshold.

In one example embodiment, the user's action threshold may ranges from 30 to 50 when a time period is 10 sec.

In one example embodiment, when the length of the time period increases, the threshold value may increase at a slower rate than an increasing rate of the length of the time period.

In one example embodiment, the type of the pre-defined URI may be a type concerning structure information on a web page.

In one example embodiment, the pre-defined URI may have an extension selected from the group consisting of html, htm, php, asp and jsp.

In one example embodiment, the DDos attack detection and response apparatus may further comprise a storage unit setting and storing the threshold differently depending on a webserver, wherein the DDoS discrimination unit may be provided the threshold from the storage unit.

In one example embodiment, the DDos attack detection and response apparatus may further comprise a discrimination control unit that compares the computed number of pre-defined URIs with the threshold value and activates the DDoS discrimination unit if the number of the pre-defined URIs is above a certain percentage of the threshold value.

### BRIEF DESCRIPTION OF THE DRAWINGS

The objects, features and advantages of the present invention will be more apparent from the following detailed description in conjunction with the accompanying drawings, in which:

FIG. 1 is a schematic diagram of a DDoS defense system, according to an embodiment of the present invention.

FIG. 2 is a block diagram of a DDoS attack detection and response unit, according to an embodiment of the present invention.

FIG. 3 is an illustrative drawing showing webpage requests directly initiated by a user's action and the following additional requests generated.

FIG. 4 is a flow chart for a method of detecting and responding a DDoS attack, according to an embodiment of the present invention.

FIG. 5 is a block diagram of a DDoS attack detection and response unit, according to another embodiment of the present invention.

FIGS. 6a to 6c are diagrams showing sample traffic data of particular websites.

### DETAILED DESCRIPTION OF EXEMPLARY EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein. Accordingly, example embodiments are to cover all modifications, equivalents, and alternatives falling within the scope of the invention.

It will be understood that, although the terms first, second, etc. may be used herein to describe various elements, these elements should not be limited by these terms. These terms are only used to distinguish one element from another.

It will be understood that, when a feature or element is referred to as being “connected” or “coupled” to another feature or element, it can be directly connected or coupled to the other element or intervening elements may be present. In contrast, when a feature or element is referred to as being “directly connected” or “directly coupled” to another element, there are no intervening elements present.

The terminology used herein is for the purpose of describing particular embodiments only and is not intended to be limiting of example embodiments of the invention. It will be understood that the terms “comprises,” or “includes,” when used herein, specify the presence of stated features, integers, steps, operations, elements, and/or components, but do not preclude the presence or addition of one or more other features, integers, steps, operations, elements, components, and/or groups thereof.

Like numbers are used throughout the drawings to refer to the same or like parts and a repetitive explanation will be omitted. Detailed descriptions of well-known functions and structures incorporated herein may be omitted to avoid obscuring the subject matter of the present invention.

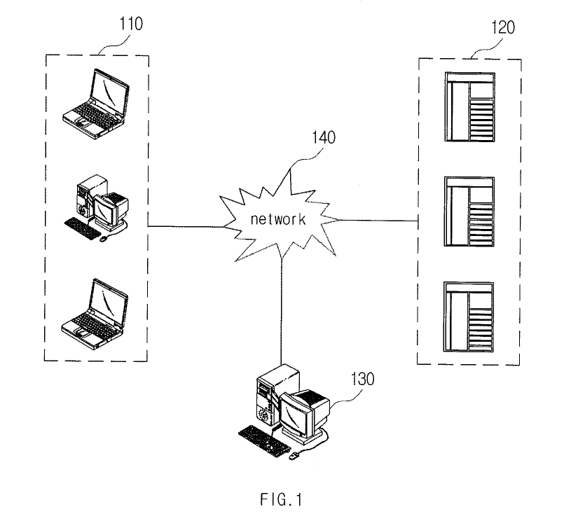

FIG. 1 is a schematic diagram representation of a DDoS defense system, according to an embodiment of the present invention. Referring to FIG. 1, the system is comprised of a client terminal 110, a Web server 120, a DDoS attack detection and response unit 130 and a network 140. The DDoS attack detection and response unit 130 may be disposed in-line with network traffic, or be deployed out-of-path where traffic information is gathered separately.

One of the features of the present invention is to classify URI types having a proportion to HTTP requests by a user's action among total HTTP requests and to perform a threshold-based DDoS attack detection. That is, the proposed DDoS defense system classifies the HTTP requests according to URI types by IP and compares those to a pre-determined threshold to cope with DDoS attacks.

Various types of GET Flooding attacks in Web services include GET Flooding with large amount of HTTP requests per unit time by IP, GET Flooding with HTTP requests above a pre-defined threshold value for a certain URIs by IP, GET Flooding with average HTTP requests per URI per unit time exceeding a pre-defined threshold value by IP, GET Flooding with abnormally distributed URI requests per unit time by IP, and GET Flooding with possibly minimal HTTP requests for many multiple URIs per unit time by IP. Such types of GET Flooding attacks in Web services are concerned with most of the past DDoS attacks such as the recent 7.7 DDoS attack, and even possible future attacks.

DDoS defense mechanisms described in the present embodiment can be effectively employed for the detection of the above-mentioned types of DDoS attacks. That is, in the present embodiment, by IP, the HTTP requests are grouped according to URI types based on a established criteria, for example, whether or not a HTTP request is initiated by a user's action, and the number of the grouped HTTP requests is compared with a threshold to detect DDoS attacks.

The client terminal 110, referred to as a so-called zombie PC, is a terminal launching a DDoS attack to the Web server 120. The DDoS attack detection and response unit 130 detects a DDoS attack from the client terminal 110 and blocks the attacking terminal 110 from accessing to the Web server 120.

The DDoS attack detection and response unit 130 may be installed in a router on the network 140, placed on a modified router, DDoS-only equipment, or invasion protection system, or equipped as a component of the Web server 120 or as a firewall. Further, although the present invention is mainly described in an example where the client terminal 110 launches a DDoS attack to the Web server 120, the present invention is not limited. For example, it is obvious to apply the present invention to other various attacks targeted toward websites, application servers, hardware units, software units, etc.

The DDoS attack detection and response unit 130 implements algorithms for detecting and responding application-layer DDoS attacks targeted mainly to Web services. That is, when a DDoS attack with possibly small amount of HTTP traffics by IP occurs, the DDoS attack detection and response unit 130 classifies the HTTP requests according to URI types and provides the DDoS defense mechanism based on the classification.

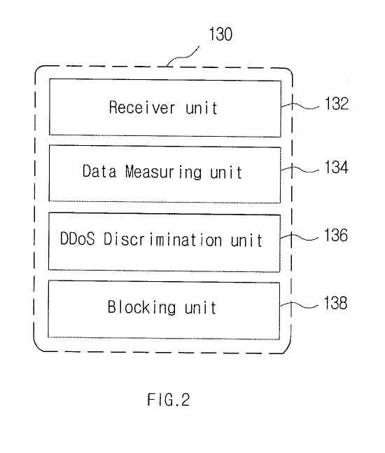

FIG. 2 is a block diagram of a DDoS attack detection and response unit, according to an embodiment of the present invention. Referring to FIG. 2, receiver unit 132, data measuring unit 134, DDoS discrimination unit 136 and blocking unit 138 are presented.

The receiver unit 132 is designed to receive HTTP requests from the client terminal 110 which is characterized as IP address. The receiver unit 132 receives HTTP packets collected in TCP 80 port and parses the HTTP headers so as to enable the data measuring unit 134 to carry out analyses.

The data measuring unit 134 is designed to compute the number of HTTP requests by IP for a time period and to classify the HTTP requests according to URI types by IP. In more detail, the data measuring unit 134 may index every received packet by IP and update information. The present embodiment may involve a separate storage unit which stores data such as IPs, time periods, the number of HTTP and the number of URIs. The hash/mod method may be applied in managing information by IP and URI. However, since it will be easily implemented by those skilled in the art related to the present invention, further description will not be provided.

According to the present embodiment, the detection and response of DDoS attacks may be implemented for a time period. The time period observed is determined in order to detect DDoS attacks in an effectively and timely manner, for example 5˜20 seconds. Due to the nature of Web services, it is difficult to study the IP-specific user behaviors on PPS basis, whereas the web service usage pattern can be analysed when observed over a certain time period.

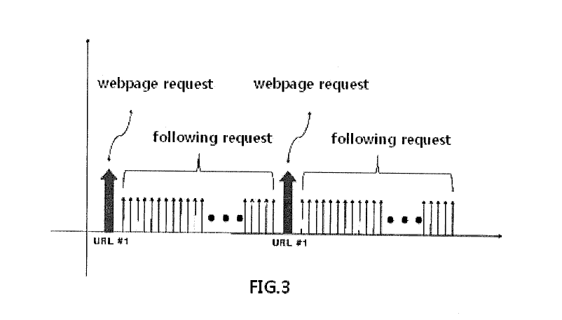

In general, with a Get Request on a website, the web server returns a response containing information with regard to image, iframe, html, flash, and so on. The web browser of the client terminal 110 generates a request to receive information, and displays the information. Referring to FIG. 3, with a webpage request initiated by a user's action, multiple following requests are generated.

HTTP Requests may be grouped into requests directly generated by a user's action and requests accompanying them. The requests by a user's action are generated, for example, when a user opens a new web browser, refreshes the current webpage possibly by pressing the F5 key or clicks on the menu or the link.

Since the HTTP requests by a user's particular action, for example, are generated by clicking the menu or the link, they are bound to be limited in number. That is, since the direct requests are made by a user's action, the possible number of user's action within a certain time period is limited and the number of direct requests is also limited. As a result of observation, it is very rare to generate three to five direct HTTP requests per second, and accordingly it is unlikely for normal users to generate thirty to fifty direct HTTP requests in 10 seconds.

Therefore, one of the features of the present embodiment is to distinguish pre-defined URIs associated with the requests by a user's action and to perform a threshold base detection, thereby defending a DDoS attack in a fairly accurate manner.

The DDoS discrimination unit 136 compares with a pre-defined threshold the number of a certain type of URIs having a proportion to the HTTP requests by a user's action among the IP-specific traffics, and defines an access of the client terminal 110 with the corresponding IP as a DDoS attack when the number of the certain type of URIs is above the threshold. For example, the number of HTTP requests by a user's action is likely to be proportional to the number of a certain URI types (e.g., html, htm, php, asp, jsp). If the number of such type of URIs is above a threshold, it may be assumed as a DDoS attack. Here, the certain type refers to a type of URIs corresponding to the files containing structure information for displaying a framed webpage (e.g., iframe), however the present invention is not limited thereto. Further any file extensions indicating a web page's structure, which may be developed and commercialized in the future, are included.

For example, if the number of the HTTP requests by a user's action per second is 3 or more, or if the number of direct HTTP requests in 10 seconds is 30 or more, the access of the client terminal 110 with the corresponding IP is then considered as a DDoS attack and it is blocked. According to the present embodiment, a threshold value of the number of the HTTP requests by a user's action may range from 30 to 50 for a time period of 10 seconds. Meanwhile, when determining a threshold value of the number of the certain type of URI, a specific percentage may be applied by websites, as will be described below.

It may be expressed by the following equation.

T=R×T_{U} (1)

Here, T is a threshold value for the number of a certain type of URI; R is a pre-determined ratio of the number of HTTP requests by a user's action to the number of the certain type of URI; TU is a threshold value for the HTTP requests by a user's action. Here, the ratio R may be determined by test data in the normal Web pages and may be stored in a storage unit. Also, the threshold value for HTTP requests by a user's action may be fixed as an initial default setting or may be manually adjusted by users.

One of the features of the present embodiment is that only the last few digits of URI or the file name extension are to be checked from the standard HTTP header, which results in enhanced performance.

The blocking unit 138 blocks access of the client terminal 110 if a DDoS attack is detected via the DDoS discrimination unit 136. With the detection of a DDoS attack, the blocking units 138 may deny access completely over a certain time period, block packets from a particular IP, or generate a warning signal. When the client terminal 110 of a particular IP address is identified as attacking terminal, the blocking unit 138 may cope with the attack by denying the access of the corresponding client terminal 110.

Further, the present embodiment may further comprise an additional unit for preliminary detection of system abnormality that is to be operated prior to the DDoS discrimination unit 136 and the blocking unit 138. Accordingly, the DDoS attack detection and response unit 130 may be operated only when abnormal symptoms are noticed including slow access to the Web server 120 and system overload, thereby reducing the server load and increasing calculation efficiency. In order for this, the present embodiment may further comprise a discrimination control unit (not shown) comparing the number of HTP requests by a user's action (or the number of a specific URI) derived from the above-described embodiments with the threshold value and activating the DDoS discrimination unit 136 if the number of the HTTP requests (or the number of a specific URI) is above a certain percentage of the threshold value.

Here, the percentage used in the preliminary detection may be fixed as a default value, automatically configured with the network or server environment, or manually adjusted by users. In the automatic configuration setting, the percentage is adjusted according to the network/server overload frequency, intensity, etc. For example, when the overloads are frequently present, the circumstance is considered suspicious and thus the percentage is increased accordingly. In the manual configuration setting, the present embodiment can include a user interface system to adjust the percentage. The percentage, for example, may be 50% to 70% of the thresholds mentioned earlier (i.e., global threshold, local threshold, average threshold).

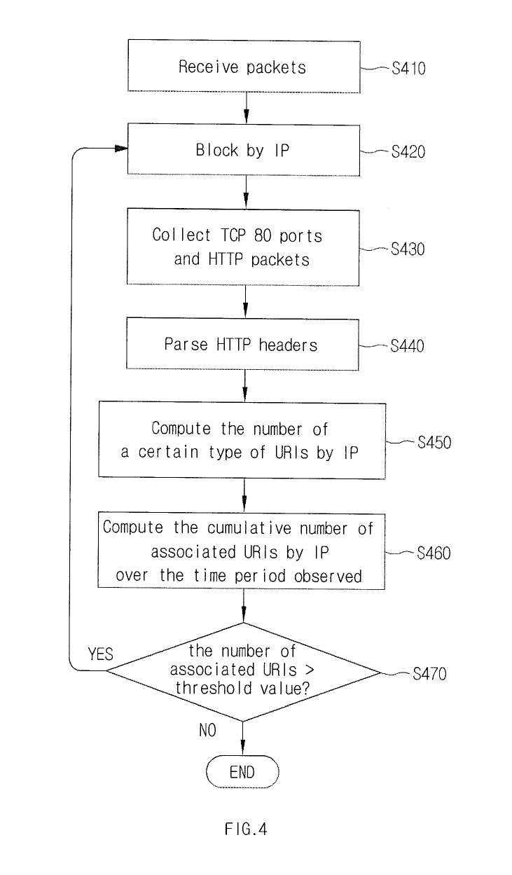

FIG. 4 is a flow chart for a method of detecting and responding a DDoS attack, according to an embodiment of the present invention. This flow chart relates to be the defense mechanism of the DDoS attack detection and response unit 130.

In step S410, a packet is received from the client terminal 110. The client terminal 110 classified as a DDoS attacker by ID is blocked in step S420. If the client terminal 110 is identified as a new IP, then the corresponding IP may be stored in a database.

TCP 80 ports and HTTP packets are collected in step S430, and HTTP headers are parsed in step S440. For example, under the present embodiment, a fast kernel-based traffic control engine may be implemented to collect HTTP packets from NDIS intermediate Driver or a kernel-object packet pool and to parse HTTP headers.

In step S450, the number of direct requests and the number of associated URIs are computed by IP. In step S460, as described earlier, the number of associated URIs over a time period T is computed by IP.

In step S470, the number of associated URIs is compared to the above-stated threshold value. If the number of associated URIs is greater than or equal to the threshold, then access from the client terminal 110 with the corresponding IP address is blocked at step S420. If the number of HTTP requests per URI is less than the threshold, the corresponding IP access is maintained.

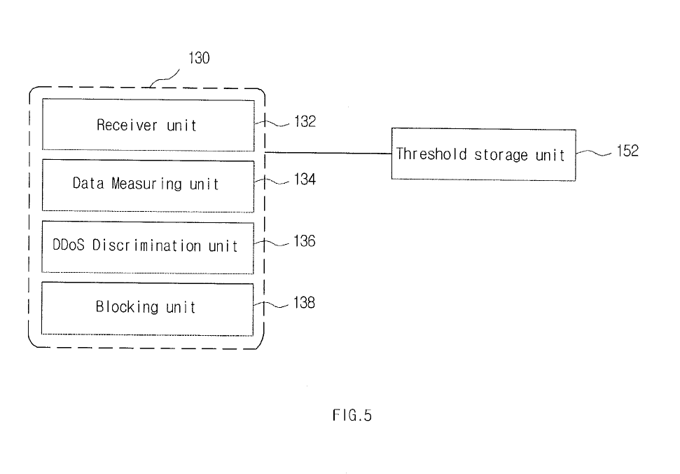

FIG. 5 is a block diagram of a DDoS attack detection and response unit, according to another embodiment of the present invention. Referring to FIG. 5, receiver unit 132, data measuring unit 134, DDoS discrimination unit 136, blocking unit 138 and threshold storage unit 152 are presented. The following description will focus on the differences from the above-described embodiment.

One of the features of the present embodiment is to compare the number of a specific type of URI, which is associated with the ratio of the number of HTTP requests by a user's action to the number of certain types of URIs, to a pre-determined threshold and to apply a possibly different threshold value for each web server in detecting a DDoS attack. A web site is organized into several pages split by, for example, an iframe, and a certain type of URIs are loaded to display contents within the frame. That is, when a HTTP request is generated by a user's action, the above-described types of URIs are subsequently requested to display the related contents on Web browser.

Therefore, according to the present embodiment, depending on the characteristics of the Web server is determined a threshold value for the number of a certain type of URIs, or a threshold value for the ratio of the number of direct HTTP requests to the number of a certain type of URIs. By employing this threshold to detect DDoS attacks, the detection can be performed more precisely. In the following description will be introduced a case where the detection of DDoS attacks targeted to multiple Web servers is based on the ratio of the number of HTTP requests by a user's action to the number of a certain type of URIs.

The threshold storage unit 152 stores the ratio of the number of HTTP requests by a user's action to the number of a certain type of URIs computed under the normal Web browsing setting for each Web server. The DDoS attack defense and response tool can be implemented within a Web server, or can be run as a separate server to monitor multiple Web servers. Accordingly, the threshold storage unit 152 may store a threshold value for a single Web server, or multiple threshold values for multiple Web servers considered. Here, as mentioned earlier, threshold values may be set for the ratio of the number of HTTP requests by a user's action to the number of a certain type of URIs or for the number of a certain type of URIs. When the former threshold ratio is multiplied by the above described user's action threshold value, the result may be the latter threshold.

The data measuring unit 134 computes the number of pre-defined type of URIs over a certain period of time by IP, and the resulting data can be separately stored in the above-described database.

As described above, the DDoS discrimination unit 136 compares the number of pre-defined type of URIs with a threshold value and considers it as a DDoS attack if the number of associated URIs is above the threshold.

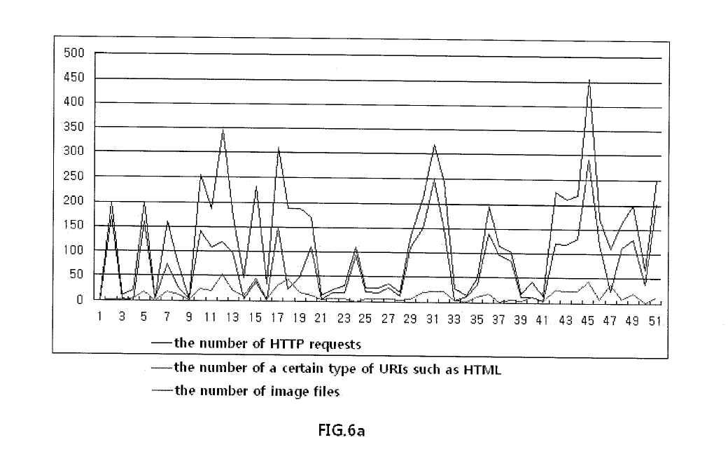

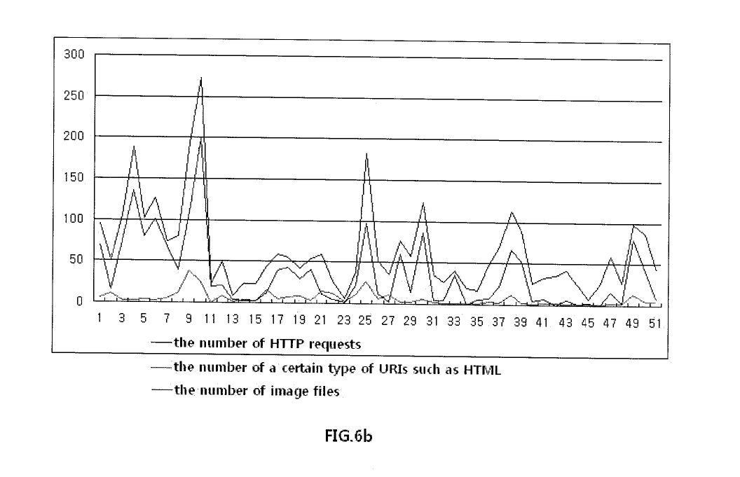

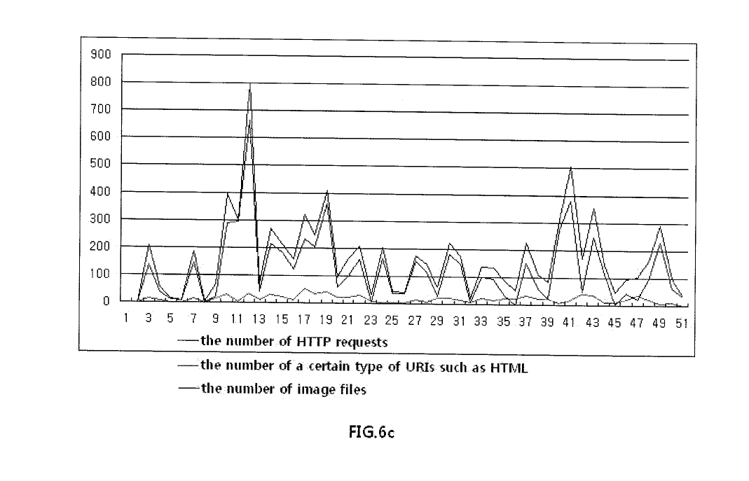

FIGS. 6a to 6c show sample traffic data of particular websites. Referring to FIGS. 6a to 6c, while a user generates 100 direct requests, the number of HTTP requests, the number of a certain type of URIs such as HTML, and the number of image files are computed and displayed by the time period of 10 seconds, in. The X-axis represents time period observed and the Y-axis represents the number of counts. Here, the unit time period is 10 seconds.

FIGS. 6a, 6b and 6c correspond to test results on websites at www.naver.com, www.nate.com and www.auction.com, respectively. The number of requests for certain types of URIs such as .html, .htm, .php, .asp, and .jsp were 727, 326 and 854 at naver, nate and auction, respectively. Therefore the ratio of the number of direct requests to the number of the certain type of URIs can be set as 1:7.2, 1:3.2, 1:8.5, respectively, and the threshold ratio can be set based on the observed ratio. If the user's action threshold for direct requests in 10 seconds is set to 30, the threshold for the number of certain types of URIs can be set to 216 (7.2*30). These thresholds may be determined as an average over multiple tests under the normal Web usage setting.

Further, in regard to the embodiments of the present invention, detailed system diagram of a DDoS detection and response tool, common platform technology such as O/S, interface standardization such as communication protocol and I/O interface are obvious to the ordinary skilled in the art, so they are omitted.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

1. An apparatus for detecting and responding to a distributed denial of service (DDoS) attack, the apparatus comprising:
a receiver unit configured to receive an HTTP request from a client terminal having a predetermined IP address;
a data measuring unit configured to compute a number of a pre-defined URI in the received HTTP request by IP for a predetermined measuring time period;
a DDoS discrimination unit configured to compare the computed number of the pre-defined URI with a pre-defined threshold and configured to detect an access of the client terminal with the IP address as the DDoS attack when the number of the pre-defined URI is greater than the threshold; and
a blocking unit configured to block the access of the client terminal when the DDoS discrimination unit detects the DDoS attack.

2. The apparatus according to claim 1, wherein the threshold is determined by the following equation:
T=R×T_{U}
where T is the threshold, R is a pre-determined ratio of a number of an HTTP requested by a user's action to the number of the pre-defined URI, and T_{U} is a user's action threshold.

3. The apparatus according to claim 2, wherein the user's action threshold ranges from 30 to 50 when the measuring time period is 10 seconds.

4. The apparatus according to claim 3, wherein when a length of the measuring time period increases, the threshold value increases at a slower rate than an increasing rate of the length of the measuring time period.

5. The apparatus according to claim 1, wherein a type of the pre-defined URI is a type concerning structure information of a web page.

6. The apparatus according to claim 1, wherein the pre-defined URI has an extension that includes html, htm, php, asp or jsp.

7. The apparatus according to claim 1, further comprising:
a storage unit configured to store the threshold that is set differently depending on a webserver, wherein the DDoS discrimination unit extracts the threshold from the storage unit.

8. The apparatus according to claim 1 further comprising a discrimination control unit configured to compare the computed number of the pre-defined URI with the threshold and activate the DDoS discrimination unit if the number of the pre-defined URI is greater than a certain percentage of the threshold.
